(19) United States
(12) Patent Application Publication
(10) Pub. No.: US 2012/0271552 A1
(43) Pub. Date: Oct. 25, 2012

(54) INCREASING THE RESOLUTION OF VSP AVA ANALYSIS THROUGH USING BOREHOLE GRAVITY INFORMATION

(76) Inventors: Yuliy A. Dashevsky, Novosibirsk (RU); Aleksandr N. Vasilevskiy, Novosibirsk (RU); Gleb V. Dyatlov, Novosibirsk (RU)

(21) Appl. No.: 13/382,330

(22) PCT Filed: Apr. 22, 2011
(86) PCT No.: PCT/RU2011/000259

§ 371 Date: May 31, 2012

(51) Int. Cl. G06F 19/00; G01V 7/06; G01V 1/28

(52) U.S. Cl. 702/17

(57) ABSTRACT

An apparatus and method for estimating at least one parameter of interest for an earth formation by reducing an uncertainty in seismic parameters using density information. The density information may be acquired from borehole gravity information. The method may include inverting seismic parameters while using density information obtained from borehole gravity information. The method may also include joint inversion of seismic parameters with density information. The apparatus may include a gravimeter and a processor configured to estimate the parameter of interest using the seismic parameters and density information.

### FIELD OF THE DISCLOSURE

This disclosure generally relates to the field of borehole seismic profiling for estimating of properties of the earth formation around a borehole.

### BACKGROUND OF THE DISCLOSURE

Seismic profiling is well known and various devices and various techniques have been described for this purpose. Seismic profiling information, such as VSP information, may be used to estimate properties (such as elastic parameters) of an earth formation surrounding a borehole. Generally, seismic parameters may be determined using the reflection of seismic waves at a boundary between a first layer and a second layer of the earth formation. At a boundary, part of the energy of an incident seismic wave traveling through the first layer may be reflected back to be detected by seismic measurement devices located at the surface or within the first layer. These reflections may provide information regarding the properties of the earth formation. Estimates of seismic parameters of an earth formation based on the seismic profiling information may be limited by the uncertainty of the seismic profiling information. The present disclosure addresses the problem of this uncertainty.

### SUMMARY OF THE DISCLOSURE

In aspects, the present disclosure relates to the field of borehole seismic profiling for estimating of properties of the earth formation around a borehole. More specifically, the disclosure addresses the problem of increasing geophysical capabilities of vertical seismic profiling (VSP) through using borehole gravity measured in the same boreholes or borehole nearby where VSP information has been acquired.

One embodiment according to the present disclosure includes a method of evaluating an earth formation, the method comprising: estimating at least one parameter of interest of the earth formation using seismic parameters and density information, wherein a processor uses the density information to reduce uncertainty in the seismic parameters.

Another embodiment according to the present disclosure includes an apparatus for evaluating an earth formation, the apparatus comprising: a gravity data log; and a processor configured to estimate at least one parameter of interest of the earth formation using seismic parameters and density information, wherein the processor uses the density information to reduce uncertainty in the seismic parameters.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a borehole gravity measurement tool deployed in a borehole along a wireline according to one embodiment of the present disclosure;

FIG. 2 shows graphs of parameter and data uncertainty using VSP information with AVA analysis according to one embodiment of the present disclosure;

FIG. 3 shows graphs of parameter and data uncertainty using VSP information and density information according to another embodiment of the present disclosure; and

FIG. 4 shows a flow chart of a method for reducing uncertainty in seismic parameter for an earth formation according to one embodiment of the present disclosure; and

FIG. 5 shows a schematic of a hardware environment for implementing one embodiment of the method according to the present disclosure.

### DETAILED DESCRIPTION

The present disclosure generally relates to the field of borehole seismic profiling, such as vertical seismic profiling (VSP) for estimating of elastic properties of the earth around a borehole. More specifically, the disclosure addresses the problem of increasing geophysical capabilities of VSP through using borehole gravity measured for the same earth formations for which VSP information has been acquired. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

Herein, the term “vertical seismic profiling” (VSP) relates measurement made in a vertical borehole with seismic measurement device disposed within the borehole and a seismic source at the surface. In one aspect, VSP may relate to any process that creates downgoing and upgoing seismic wavefields within the earth and then records both wavefields simultaneously. Either the source(s) or the receiver(s), or both, must be in the subsurface for these conditions to be satisfied. VSP may be used to estimate seismic parameters of an earth formation.

Herein, the term “AVA” (amplitude variation with angle) analysis relates to a technique which allows us to assess variations in seismic reflection amplitude with changes in angle of incidence. Conventional AVA analysis may be based on Zoeppritz equations. These equations describe the various reflection and transmission coefficients for plane waves as a function of angle of incidence, θ, the elastic constants and the densities of the two halfspaces.

Herein, the term “borehole gravity data” relates to values of vertical and/or horizontal components of gravitational acceleration measured in a borehole. The borehole may be the same or in close proximity to the boreholes where VSP signals have been acquired.

Herein, the term “information” relates to raw data, processed data, direct measurements, indirect measurements, and signals.

Herein, the following relations between elastic constants and wave velocities of P-wave velocity Vₚ and S-wave velocity Vₛ hold true:

$${V}_{p} \sqrt{\frac{k + \frac{4}{3} μ}{ρ}} , {V}_{s} = \sqrt{\frac{μ}{ρ}} , k = λ + \frac{2}{3} μ , \qquad ( 1 )$$

where

ρ—formation density;

k—bulk modulus of the medium (incompressibility).

λ—1^{st} Lame′ parameter.

μ—2^{nd} Lame′ parameter or rigidity modulus of the medium (shear modulus);

The geophysical capabilities of seismic profiling (such as VSP) may be increased through the use of borehole gravity data. Different components of gravitational acceleration for an earth formation may be measured in the same boreholes where VSP information has been acquired or in boreholes located near VSP boreholes. The gravity information may be used to increase the resolution of VSP and to obtain improved estimates of elastic parameters of the formation surrounding the borehole at different depths. These improvements may be obtained by 1) using density information based on the gravity information as a priori data in combination with VSP information and/or 2) performing a joint inversion of a combination of VSP and gravity information.

A layer of an earth formation may be characterized by the layer's seismic parameters understood by those of skill in the art (P-wave velocity, S-wave velocity, density, etc.) Since an earth formation typically includes more than one homogenous layer, the boundary between two layers may include seismic parameters based on the seismic parameters of the adjacent layers. These boundary seismic parameters may include transmission coefficients, reflectivity coefficients, etc. The density information may include a space distribution of density. Estimates of rock density over a volume extending over hundreds of feet from the borehole may be obtained using the space distribution of density estimated from gravity information.

The use of seismic parameters to estimate at least one parameter of interest of the earth formation may involve inverting the values of the seismic parameters. Parameter of interest may include, but are not limited to, one or more of: i) a P-wave velocity in the first formation layer ii) a P-wave velocity in the second formation layer, iii) a difference between the P-wave velocity in the first formation layer and the P-wave velocity in the second formation layer, iv) an S-wave velocity in the first formation layer, v) an S-wave velocity in the second formation layer, vi) a difference between the S-wave velocity in the first formation layer and the S-wave velocity in the second formation layer vii) a density of the first formation layer, viii) a density of the second formation layer, ix) a difference between the density of the first formation layer and the density of the second formation layer, x) elastic constants of the first formation, and xi) elastic constants of the second formation. In one non-limiting embodiment, the procedure of inverting VSP information for the elastic parameters may include estimating reflectivity of the earth formation. Reflectivity may be estimated as a function of incidence angle for each point in the subsurface. In some aspects, true amplitude migration may be used to obtain angle-dependent reflectivity. Inverting VSP information may also include performing a mathematical inversion. The goal of the inversion may be achieved by minimizing the misfit between the angle-dependent reflectivity information and synthetic information obtained from numerical modeling of Zoeppritz equations.

Improved density information regarding a formation may allow for better inversion of seismic information. AVA analysis may not provide density information with adequate accuracy for the desired quality of VSP measurements. Density information for the formation surrounding a borehole may be obtained through an number of techniques, including, but not limited to, one or more of: i) gamma density logging, ii) acoustic density logging, and iii) borehole gravity logging.

Gamma density logging and acoustic density logging may provide a shallow depth of investigation (several inches to several feet), while the density information obtained from the borehole gravity logging may relate to large areas far from the borehole (hundreds of feet). The depth of investigation of borehole gravity logging may be comparable to the area covered by VSP measurement. The borehole gravity log information may include at least one of: i) vertical gravity component information and ii) horizontal gravity component information. A non-limiting embodiment of an apparatus configured to obtain density information for the earth formation is described below.

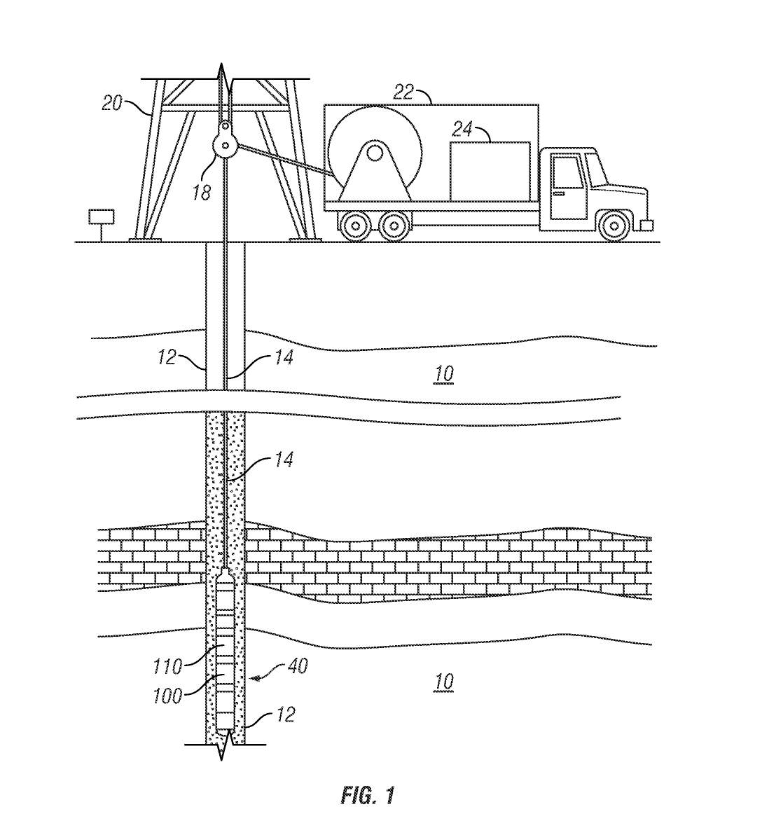

FIG. 1 shows one non-limiting embodiment according to the present disclosure wherein a cross-section of a subterranean formation 10 in which is drilled a borehole 12 is schematically represented. Suspended within the borehole 12 at the bottom end of a carrier 14, such as a wireline, is formation evaluation tool 40. In some embodiments, the carrier 14 may be rigid, such as a coiled tube, casing, liners, drill pipe, etc. In other embodiments, the carrier 14 may be non-rigid, such as wirelines, wireline sondes, slickline sondes, e-lines, drop tools, self-propelled tractors, etc. The term “carrier” as used herein means any device, device component, combination of devices, media and/or member that may be used to convey, house, support, or otherwise facilitate the use of another device, device component, combination of devices, media and/or member. The formation evaluation tool 40 may include a gravimeter 100. The carrier 14 may be carried over a pulley 18 supported by a derrick 20. Wireline deployment and retrieval is performed by a powered winch carried by a service truck 22, for example. A control panel 24 interconnected to the gravimeter 100 through the carrier 14 by conventional means controls transmission of electrical power, data/command signals, and also provides control over operation of the components in the measurement device 100. In some embodiments, the borehole 12 may be utilized to recover hydrocarbons. In other embodiments, the borehole 12 may be used for geothermal applications or other uses. In some embodiments, the gravimeter 100 may also be located on the surface, near the top of the borehole 12. The formation evaluation tool 40 may also include a vector magnetometer 110.

The gravimeter 100 may be a multi-component device with a predetermined orientation, such as an angular orientation. The gravimeter 100 may also include control electronics. The control electronics may be in the borehole or in at a surface location. The gravimeter 100 may provide components of the gravity vector that may be known under that local coordinate system of the gravimeter, however, this information may not be usable the orientation of the local coordinate system with respect to a global reference system, or at least a reference system that is valid over a region or volume that includes the earth formation, is unknown.

In some embodiments, the formation evaluation tool 40 may be configured to deploy the gravimeter 100 within the borehole 12 to a fixed position. Here, the gravimeter 100 may be detachable from the formation evaluation tool 40. The precise position of the gravimeter 100 may be estimated using methods well known within the hydrocarbon production community. An example would be to use the depth as measured along the borehole in combination with data from a well survey. At the selected depth, the gravimeter 100 may be positioned against the borehole wall 12, such as by a mechanism like a hydraulic cylinder, and attached to the earth formation or borehole casing by some method known to those skilled in the art of permanent sensing.

Once the borehole gravity information is obtained, it may be combined with VSP information. One method of combining VSP and borehole gravity information may include using the borehole gravity information with the layered earth model to find the density along the borehole, as well as, the density and the difference in the density between every pair of layers (for every interface). Then these values may be used as exact values in inversion of the VSP information through the AVA analysis (the conventional scheme assumes that we know only the mean density). The density of a layer may be obtained using gravity information. The density may be estimated using any mathematical operation known to those of skill in the art for converting gravity information into density information, including, but not limited to, inversion equations.

Another method for combining VSP and borehole gravity information may include a joint inversion, where VSP and borehole gravity information are inverted together. Mathematically, this combined inversion assumes a minimization of the combined goal functional misfit. In some embodiments, the joint inversion method may use a solution obtained by the VSP inversion only method as a starting point.

Greater precision in density information for portions of the earth formation far from the borehole, which may be obtained using borehole gravity information, may improve the accuracy of the AVA analysis. The accuracy of AVA analysis may be understood in terms of conditional uncertainty, where the uncertainty of indicators like Δ(V_{P}/V_{S}) improve when Δρ is given with higher accuracy.

Suppose that the parameters xⱼ, j=n , of the model and the data yᵢ, i=1, . . . , N, are connected by a linear map. The map

(x₁, . . . , xₙ) [symbol] (y₁, . . . , y_{N}) (2)

is called the forward map. If there is sufficient information for determination of the parameters, then the inverse map

(y₁, . . . , y_{N}) [symbol] (x₁, . . . , xₙ) (3)

arises. A change of the parameters x=(x₁, . . . , xₙ) by δx=(δx₁, . . . , δxₙ) may result in a change of the data y=(y₁, . . . , y_{N}) by δy=(δy₁, . . . , δy_{N}). And vice versa, a variation δy of the data may be caused by some variation δx of the parameters.

A measure of the variation of data may be a norm

$$‖ δ y ‖ = \sqrt{〈 C δ y , δ y 〉} = \sqrt{{\sum }_{i , k = 1}^{N} {c}_{ik} δ {y}_{i} δ {y}_{k}} , \qquad ( 4 )$$

where [symbol] .,. [symbol] denotes the Euclidean inner product and C=(cᵢₖ) is a positive definite symmetric matrix called the covariance matrix. If all data have the same nature and scale, then C may be taken to be the identity matrix.

Assuming that some (unknown) variation of the parameters δx=(δx₁, . . . , δxₙ) may lead to a variation δy of data and some parameter

$$G = {\sum }_{j = 1}^{n} {g}_{j} {x}_{j}$$

is a linear combination of xⱼ. Then, the maximal possible value of |δG|,

$$δ G = {\sum }_{j = 1}^{n} {g}_{j} δ {x}_{j} ,$$

over all variations δx=(δx₁, . . . , δxₙ) which lead to variations δy with ∥δy∥≦δ₀ is called the uncertainty of_G corresponding to the data uncertainty δ₀. Herein, the maximal possible value of |δG| is denoted by δG^{max}.

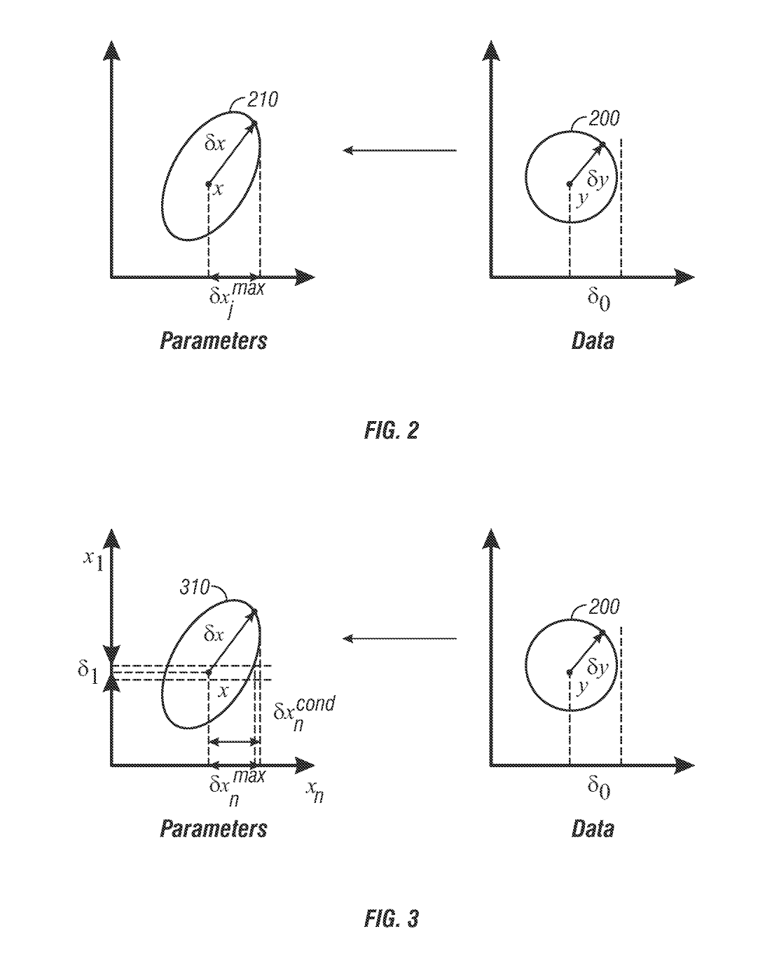

FIG. 2 shows a simple case of G=xⱼ, the inverse map the data uncertainty ball 200 of radius δ₀ goes into some ellipsoid 210 in the parameter space. The uncertainty δxⱼ^{max} is the half of the projection of this ellipsoid to the xⱼ-axis.

Once the dependence of the data on the parameters is linear, i.e.,

$${y}_{i} = {\sum }_{j = 1}^{n} {a}_{ij} {x}_{j} , i = 1 , … , N , \qquad ( 5 )$$

the variations δy and δx are connected by the same matrix A=(aᵢⱼ) :

$$δ {y}_{i} = {\sum }_{j = 1}^{n} {a}_{ij} δ {x}_{j} , i = 1 , … , N . \qquad ( 6 )$$

Hence, it suffices to find δG^{max} for a single value δ₀.

Mathematically, the problem of finding the uncertainty δG^{max} may be stated as the constrained maximization problem

$$\{ \begin{matrix} \vert δ G \vert -> max , \\ 〈 B δ x , δ x 〉 \leq {δ}_{0} ,\end{matrix} \qquad ( 7 )$$

with the positive definite symmetric matrix B=A^{T} CA called the information matrix.

When estimating the uncertainty of some parameter

$$G = {\sum }_{j = 1}^{n} {g}_{j} {x}_{j} ,$$

other parameters may be known with some accuracy (say the parameters with numbers n(1), . . . , n(k)), i.e., their variations do not exceed some values

|δxₙ₍ₗ₎|≦δₗ, l=1, . . . k, (8)

where k≦n is the number of additional conditions.

The maximal value of |δG|,

$$δ G = {\sum }_{j = 1}^{n} {g}_{j} δ {x}_{j} ,$$

over all variations δx=(δx₁, . . . , δxₙ) such that |δxₙ₍ₗ₎|≦δₗ, l=1, . . . k, which lead to data variations δy with ∥δy∥≦δ₀ is called the conditional uncertainty of G. Herein the maximal value of conditional uncertainty of |δG| is denoted by δG^{cond}.

FIG. 3 shows an example of how the presence of additional conditions may improve the uncertainty. In particular, when k=n−1 and δₗ=0, l=1, . . . , n−1, the conditional uncertainty δxₙ^{cond} equals 1 over the sensitivity of data to the parameter xₙ. Hence, the conditional uncertainty projection of the truncated ellipsoid 310 based on data uncertainty 200 may be smaller than the whole one 210 (FIG. 2).

Mathematically, the conditional uncertainty δG^{cond} may be found by solving the constrained maximization problem

$$\{ \begin{matrix} \vert {\sum }_{j = 1}^{n} {g}_{j} δ {x}_{j} \vert -> max , \\ 〈 C A δ x , A δ x 〉 \leq {δ}_{0}^{2} , \\ \vert δ {x}_{n ( l )} \vert \leq {δ}_{l} , l = 1 , … , k .\end{matrix} \qquad ( 9 )$$

One non-limiting technique for solving the constrained maximization problem includes a general maximization problem arising in conditional linear uncertainty analysis solution. For example, to determine the uncertainty of parameter

$$G = {\sum }_{j = 1}^{n} {g}_{j} {x}_{j}$$

while k conditions are imposed on the parameters with numbers n(1), . . . , n(k), 0≦k≦n. The generic problem requiring solution may be

$$\{ \begin{matrix} \vert G \vert -> max \\ 〈 C A x , A x 〉 \leq {δ}_{0}^{2} \\ \vert {x}_{n ( l )} \vert \leq {δ}_{l} , l = 1 , … , k .\end{matrix} \qquad ( 10 )$$

where x is substituted for δx for purposes of illustrating the generic solution.

Denoted by U the set on which the maximum of f(x)=|G| is sought; i.e.,

U={x: [symbol] CAx, Ax [symbol] =δ₀², |xₙ₍ₗ₎|≦δₗ, l=1, . . . , k}.

The set U is closed and bounded; therefore, f(x) attains its greatest value on U. However, finding the greatest value on such a set straightforwardly is not a simple problem. We will represent U as the union of simpler sets on each of which the greatest value can be found by a standard method.

Let

S₀={x: [symbol] CAx, Ax [symbol] =δ₀²} (11)

Let p=0, . . . , k be the number of “active” conditions and let 1≦β(1) < . . . <β(p)≦k be the numbers of the selected conditions. Denoted by Bₚ may be the set of all integer-valued vectors β=(β(1), . . . , β(p)) with the indicated condition. The set Bₚ comprises

$$( \begin{matrix}k \\ p\end{matrix} )$$

elements. Extending each β ∈ Bₚ to a substitution of length k such that) β(p+1)< . . . <β(k), thus keeping the former notation β for the extended vector. For every p=0, . . . , p and β ∈ Bₚ introduce the set

S_{p,β}={x | S₀:|x_{n(β(l))}|=δ_{β(l)}, l=1, . . . , p, |x_{n(β(l))}|≦δ_{β(l)}, l=p+1, . . . , k}. (12)

Each set S_{p,β} is the union of 2^{p} pieces of (n−p)-dimensional spheres

S_{p,β,s}={x ∈ S₀:x_{n(β(l))}=sₗδ_{β(l)}, l=1, . . . , p, |x_{n(β(l)}|<δ_{β(l)}, l=p+1, . . . , k}. (13)

where vectors s=(s₁, . . . , sₚ) have components sₗ=±1. There are 2^{p} such vectors with their sets denoted by Σₚ.

### Eventually,

$$U = {⋃}_{p = 0 , … , k} {⋃}_{β ∈ {B}_{p}} {S}_{p , β} = {⋃}_{p = 0 , … , k} {⋃}_{β ∈ {B}_{p}} {⋃}_{s ∈ {Σ}_{p}} {S}_{p , β , s} . \qquad ( 14 )$$

Let M_{p,β,s} equal the greatest value of f(x) on S_{p,β,s} if f(x) has the greatest value of this set and −∞ otherwise. Thus,

$$M = {max}_{U} f ( x ) = {max}_{p , β , s} {M}_{p , β , s} . \qquad ( 15 )$$

Now, the remaining question is that of finding the greatest value of f(x) on each S_{p,β,s}. Note that S_{p,β,s} is a manifold without boundary on the (n−p)-dimensional sphere

S̅_{p,β,s}={x ∈ S₀:x_{n(β(l))}=sₗδ_{β(l)}, l=1, . . . , p}. (16)

If f(x) attains the greatest value on S_{p,β,s}, this greatest value may occur only at a critical point (a point at which all partial derivatives are zero). All critical points of f(x) on S_{p,β,s} may be found using the algorithm described below. If at least one of the critical points belongs to S_{p,β,s}, then M_{p,β,s} is set to be the maximum of values of f(x) at these critical points. Otherwise, M_{p,β,s}=−∞.

Prior to applying the algorithm for finding critical points, the parameters may be rearranged such that the components with “active” conditions come first followed by the components with “inactive” conditions and then the “free” components. This rearrangement may be achieved by using the substitution σ defined as follows:

σ(l)=n(β(l)), l=1, . . . , k, σ(l)=n(l), l=k+1, . . . , n. (17)

Interchanging columns may change the matrix Λ to the new matrix Λ^{σ} with entries aᵢⱼ^{σ}=a_{iσ(j)}. Also, new variables xⱼ^{σ}=x_{σ(j)} and the new vector gⱼ^{σ}=g_{σ(j)} may be introduced so as to arrive at the following problem: find the critical values of

$${f}^{σ} ( {x}^{σ} ) = \vert {\sum }_{j = 1}^{n} {g}_{j}^{σ} {x}_{j}^{σ} \vert$$

[symbol]

CA^{σ}x^{σ}, A^{σ}x^{σ} [symbol] =δ₀², xₗ^{σ}=sₗδ_{β(l)}, l=1, . . . , p. (19)

on the set
Herein, when solving for the critical points, the notation will drop the superscript a and denote B=A^{T} CA and dₗ=sₗδ_{β(l)}. Using these notations, the critical points of the function

$$\vert {\sum }_{j = 1}^{n} {g}_{j} {x}_{j} \vert$$

on the set

{x: [symbol] Bx, x [symbol] =δ₀², xₗ=dₗ, l=1, . . . , p} (20)

may be determined.

First, the variables may be separated into two groups: x=(x₁, . . . , xₚ, z₁, . . . , zₘ), where m=n−p, and B may be expressed as a block matrix

$$B = ( \begin{matrix}{B}_{0} & {D}^{T} \\ D & C\end{matrix} ) \qquad ( 21 )$$

where B₀ is the (p×p)-matrix, D is the (m×p)-matrix, and C is the (m×m)-matrix. The single value determinant of the matrix C corresponding to the unconstrained variables: z₁, . . . , zₘ: C=UΛU^{T}, where Λ=diag(λ₁, . . . , λₘ), U=(uᵢⱼ) may be calculated, and then the new variables y=U^{T} Z may be introduced. Next,

$${z}_{j} = {\sum }_{l = 1}^{m} {u}_{jl} {y}_{l} ,$$

since UU^{T}=U^{T}U=id.

Using the conditions xₗ=dₗ, l=1, . . . , p, and passing to the new variables, the first condition may be transformed

$$\begin{matrix}〈 Bx , x 〉 = {\sum }_{i , j = 1}^{p} {b}_{ij} {d}_{i} {d}_{j} + 2 {\sum }_{i = 1}^{p} {\sum }_{j = 1}^{m} {b}_{i , j + p} {d}_{i} {z}_{j} + {\sum }_{i , j = 1}^{m} {b}_{i + p , j + p} {z}_{i} {z}_{j} \\ = d + 2 {\sum }_{l = 1}^{m} {c}_{l} {y}_{l} + {\sum }_{i = 1}^{m} {λ}_{i} {y}_{i}^{2} {,}_{ } \\ where & ( 22 ) \\ d = {\sum }_{i , j = 1}^{p} {b}_{ij} {d}_{i} {d}_{j} , {c}_{l} = {\sum }_{i = 1}^{p} {\sum }_{j = 1}^{m} {b}_{i , j + p} {d}_{i} {u}_{jl} . & ( 23 )\end{matrix}$$

Thus, the problem takes the form

$$\{ \begin{matrix}\vert {\sum }_{l = 1}^{m} {\sum }_{j = 1}^{m} {g}_{j + p} {u}_{jl} {y}_{l} \vert -> max \\ {\sum }_{i = 1}^{m} {λ}_{i} {y}_{i}^{2} + 2 {\sum }_{l = 1}^{m} {c}_{l} {y}_{l} + d - {δ}_{0}^{2} = 0.\end{matrix} \qquad ( 24 )$$

This problem may be solved using the Lagrange multipliers. Let

$$L ( y , α ) = {\sum }_{l = 1}^{m} {\sum }_{j = 1}^{m} {g}_{j + p} {u}_{jl} {y}_{l} - α ( {\sum }_{i = 1}^{m} {λ}_{i} {y}_{i}^{2} + 2 {\sum }_{l = 1}^{m} {c}_{l} {y}_{l} + d - {δ}_{0}^{2} ) . \qquad ( 25 )$$

The critical points are found from the conditions

$$\begin{matrix}\frac{\partial L}{\partial {y}_{i}} = {\sum }_{j = 1}^{m} {g}_{j + p} {u}_{ji} - α ( 2 {λ}_{i} {y}_{i} + 2 {c}_{i} ) = 0 , & ( 26 ) \\ - \frac{\partial L}{\partial α} = {\sum }_{i = 1}^{m} {λ}_{i} {y}_{i}^{2} + 2 {\sum }_{l = 1}^{m} {c}_{l} {y}_{l} + d - {δ}_{0}^{2} = 0. & ( 27 )\end{matrix}$$

Express

$${y}_{i} = \frac{{U}_{i} - 2 α {c}_{i}}{2 α {λ}_{i}} , {U}_{i} = {\sum }_{j = 1}^{m} {g}_{j + p} {u}_{ji}$$

from the first and insert them into the second:

$${\sum }_{j = 1}^{m} {λ}_{j} \frac{{( {U}_{j} - 2 α {c}_{j} )}^{2}}{4 {α}^{2} {λ}_{j}^{2}} + 2 {\sum }_{j = 1}^{m} {c}_{j} \frac{{U}_{j} - 2 α {c}_{j}}{2 α {λ}_{j}} + d - {δ}_{0}^{2} = 0. \qquad ( 28 )$$

Solving for α gives

$${μ}_{\pm } := \frac{1}{2 {α}_{\pm }} = \pm \frac{\sqrt{{{\sum }_{j = 1}}^{m} {c}_{j}^{2} / {λ}_{j}^{2} + {δ}_{0}^{2} - d}}{\sqrt{{\sum }_{j = 1}^{m} {U}_{j}^{2} / {λ}_{j}^{2}}} , \qquad ( 29 )$$

if the expressions under the square roots are positive. If the square roots are negative, then the set on which the critical points are sought is empty and there are no critical points.

Once μ_{±} are defined, two critical points x^{±}=(x₁^{±}, . . . , xₙ^{±}) (in the degenerate case they may coincide) may be obtained, where

$${x}_{i}^{\pm } = {\sum }_{j = 1}^{m} {u}_{ij} ( \frac{{μ}_{\pm } {U}_{j} - {c}_{j}}{{λ}_{j}} ) . \qquad ( 30 )$$

After the maximization problem solution has been found, estimating the seismic parameters may proceed. If the reflection coefficients R^{PP}(θ) are known for a number of angles θⱼ, j=1, . . . , m, in some range, and the objective is to determine some parameter G depending on the velocities and densities, for example, the change of the P-impedance ΔI_{P}=I_{P1}−I_{P2}=V_{P1}ρ₁−V_{P2}ρ₂, then our goal is to estimate the (conditional) uncertainty of G, provided that R^{PP}(θ) and some parameters are known with certain accuracy. This may be accomplished using the parameters:

x₁=V_{P}, x₂=ΔV_{P}, x₃=V_{S}, x₄=ΔV_{X}, x₅=_{ρ}, x₆=Δ_{ρ}

After selected a set of parameters V_{P1}, V_{P2}, V_{S1}, V_{S2}, ρ₁, ρ₂ (or point x₁, . . . , x₆) and passing from the map (x₁, . . . , x₆) [symbol] R^{PP}(θⱼ) to its linear approximation and replacing the parameter G with its linear analog, then the variations δx, δR^{PP}, δG are connected by the linear maps as follows:

$$δ {R}^{PP} ( {θ}_{j} ) = {\sum }_{k = 1}^{6} {a}_{jk} δ {x}_{k} , … , {a}_{jk} = \frac{\partial {R}^{PP} ( {θ}_{j} )}{\partial {x}_{k}} , \\ δ G = {\sum }_{k = 1}^{6} {g}_{k} δ {x}_{k} , {g}_{k} = \frac{\partial G}{\partial {x}_{k}} . \qquad ( 31 )$$

Thus, the problem is

$$\{ \begin{matrix}\vert {\sum }_{k = 1}^{6} {g}_{k} δ {x}_{k} \vert -> max \\ ‖ {\sum }_{k = 1}^{6} {a}_{jk} δ {x}_{k} ‖ \leq {δ}_{0} , \\ \vert δ {x}_{l} \vert \leq {δ}_{l} , l = 1 , … , 6 ,\end{matrix} \qquad ( 32 )$$

(some of δₗ may equal ∞, which means that there may be no information about the corresponding parameter).

The result may depend on the set of parameters V_{P1}, V_{P2}, V_{S1}, V_{S2}, ρ₁, ρ₂ around which the map is linearized. For this example, there are four real sets of parameters (Table 1). The upper layer is shale and the lower layer is gas saturated sand.

TABLE 1
Parameters of layers (velocities in m/s and densities in g/cm³)

| Set | V_{P1} | V_{P2} | V_{S1} | V_{S2} | ρ₁ | ρ₂ |
|---|---|---|---|---|---|---|
| 1 | 2249 | 2458 | 731 | 1612 | 2.14 | 1.89 |
| 2 | 2743 | 2835 | 1395 | 1762 | 2.06 | 2.06 |
| 3 | 2898 | 2857 | 1290 | 1666 | 2.425 | 2.275 |
| 4 | 3811 | 3453 | 2263 | 2302 | 2.4 | 2.1 |

For this example, R^{PP}(θ) is given with an accuracy of 10%; i.e., ∥δR^{PP}∥≦0.1≦R^{PP}∥, and only a priori information is available for the mean values V_{P}, V_{S}, ρ, namely δ₁=δ₃=δ₅=0. Under these conditions, using the above algorithm, the (conditional) uncertainty of the parameters

ΔV_{P}, ΔV_{S}, Δρ, Δ(V_{P}/V_{S}), Δ(V_{P}ρ), Δ(V_{S}ρ).

result in the four sets of parameters given in Table 2.

TABLE 2
Uncertainty of parameters (velocities in m/s and densities in g/cm³)

| Set | ΔV_{P} | ΔV_{S} | Δρ | Δ(V_{P}/V_{S}) | Δ(V_{P}ρ) | Δ(V_{S}ρ) |
|---|---|---|---|---|---|---|
| 1 | 2406.42 | 2598.58 | 2.003 | 4.312 | 677.08 | 4105.90 |
| 2 | 499.37 | 389.78 | 0.345 | 0.137 | 136.70 | 340.97 |
| 3 | 926.76 | 723.80 | 0.716 | 0.375 | 274.28 | 863.86 |
| 4 | 1311.18 | 838.14 | 0.764 | 0.049 | 399.81 | 416.15 |
| Range | 1600 | 1500 | 0.5 | 1.57 | 5260 | 4300 |
| width | | | | | | |

The uncertainties of the different parameters may be compared by rescaling. Hence each uncertainty may be divided by its corresponding range width, i.e., the difference between the maximal and minimal possible values of the parameter. If the uncertainty is greater than the range width, then the parameter cannot be determined. The uncertainties of the listed parameters divided by the corresponding range widths are given in Table 3.

TABLE 3
Uncertainty of parameters divided by the range width

| Set | ΔV_{P} | ΔV_{S} | Δρ | Δ(V_{P}/V_{S}) | Δ(V_{P}ρ) | Δ(V_{S}ρ) |
|---|---|---|---|---|---|---|
| 1 | 1.50 | 1.73 | 4.00 | 2.745 | 0.129 | 0.955 |
| 2 | 0.31 | 0.26 | 0.69 | 0.087 | 0.026 | 0.079 |
| 3 | 0.58 | 0.48 | 1.43 | 0.238 | 0.052 | 0.201 |
| 4 | 0.82 | 0.56 | 1.53 | 0.031 | 0.076 | 0.097 |

Table 3 indicates that uncertainty may depend strongly on the situation. In set 1, the uncertainty of all parameters except Δ(V_{P}ρ) are very large. In sets 1, 3, and 4, the change in density exceeds the range width, thus indicating that the density may not be determined through inversion of seismic parameters. Finally, the change in P-impedance Δ(V_{P}ρ) may have a lower uncertainty than other uncertainty parameters.

In contrast to the above example, uncertainty of parameters may be determined using additional information about density. Herein, it is assumed that the change of density on the reflecting boundary is known with some accuracy from some other source, for example, from inversion of borehole gravity information. Namely, assuming that δ₆=0, . . . , 0.5 (g/cm³) and evaluating again the (conditional) uncertainty of the same parameters.

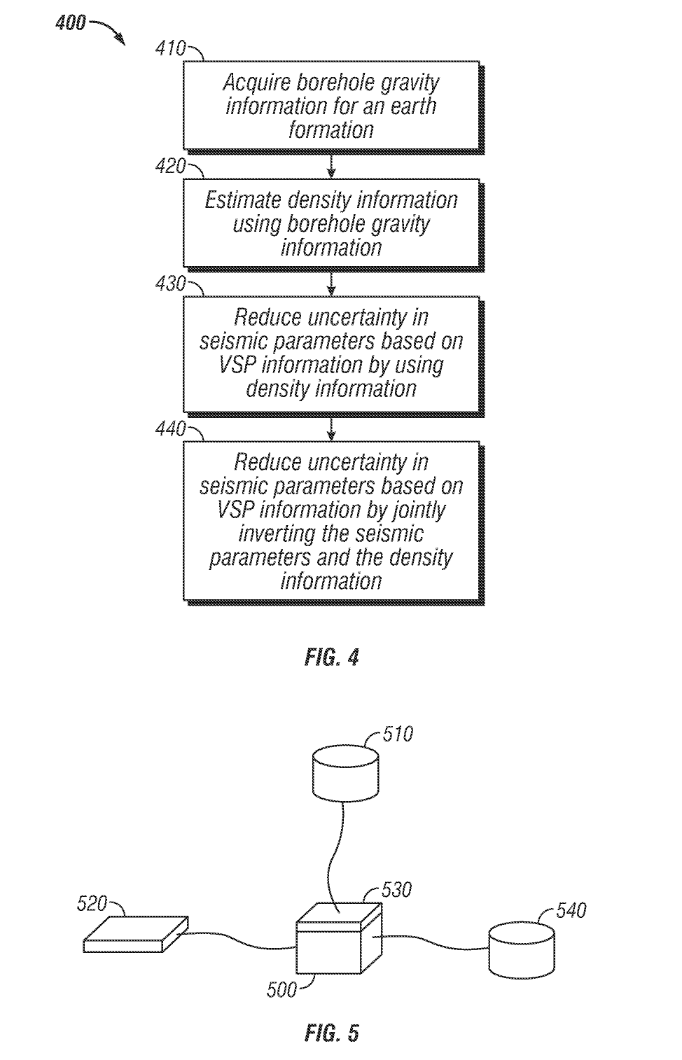

FIG. 4 shows a method 400 according to one embodiment of the present disclosure. In step 410, borehole gravity information may be gathered for an earth formation where VSP information is available. In step 420, density information for the layers of the earth formation may be estimated using borehole gravity information. In step 430, seismic parameters may be estimated by inverting the seismic parameters based on VSP information while using the density information for the density parameters. In step 440, the seismic parameters may be estimated by jointly inverting the seismic parameters and the density information estimated using he borehole gravity information. In some embodiments, step 430 may be optional. In other embodiments, step 440 may be optional.

The results of method 400 using the information from Tables 1-3 may be seen in Tables 4-6. Table 4 shows the improvement of uncertainty due to knowledge of density where the density accuracy is improved from 0.5 g/cm³ to 0.05 g/cm³. Table 5 shows the uncertainty when the density accuracy is 0.05 g/cm3. Table 6 shows the uncertainty for the density accuracy of 0.5 g/cm3. Tables 5 and 6 correspond to the unimproved density accuracy found in Table 2.

TABLE 4
Improvement of uncertainty due the knowledge of density. The ratios of
uncertainties in the last four plots at 0.5 and 0.05.

| Set | ΔV_{P} | ΔV_{S} | Δρ | Δ(V_{P}/V_{S}) | Δ(V_{P}ρ) | Δ(V_{S}ρ) |
|---|---|---|---|---|---|---|
| 1 | 4.22 | 2.78 | 10.0 | 2.38 | 1.56 | 2.37 |
| 2 | 3.95 | 3.09 | 6.91 | 1.93 | 1.08 | 1.79 |
| 3 | 4.57 | 3.27 | 10.0 | 2.20 | 1.18 | 2.11 |
| 4 | 4.25 | 3.89 | 10.0 | 1.03 | 1.15 | 1.21 |

TABLE 5
Uncertainty for the density accuracy 0.05 g/cm³
(velocities in m/s and densities in g/cm³⁾.

| Set | ΔV_{P} | ΔV_{S} | Δρ | Δ(V_{P}/V_{S}) | Δ(V_{P}ρ) | Δ(V_{S}ρ) |
|---|---|---|---|---|---|---|
| 1 | 166.4 | 301.5 | 0.05 | 0.681 | 241.96 | 653.6 |
| 2 | 126.4 | 118.5 | 0.05 | 0.071 | 126.24 | 189.2 |
| 3 | 155.2 | 169.5 | 0.05 | 0.153 | 231.44 | 374.1 |
| 4 | 225.6 | 178.5 | 0.05 | 0.049 | 347.16 | 344 |

TABLE 6
Uncertainty for the density accuracy 0.5 g/cm³
(velocities in m/s and densities in g/cm³⁾.

| Set | ΔV_{P} | ΔV_{S} | Δρ | Δ(V_{P}/V_{S}) | Δ(V_{P}ρ) | Δ(V_{S}ρ) |
|---|---|---|---|---|---|---|
| 1 | 702.4 | 838.5 | 0.5 | 1.623 | 378.72 | 1548 |
| 2 | 499.2 | 366 | 0.345 | 0.136 | 136.76 | 339.7 |
| 3 | 708.8 | 555 | 0.5 | 0.339 | 273.52 | 791.2 |
| 4 | 958.4 | 604.5 | 0.5 | 0.05 | 399.76 | 417.1 |

Generally, the velocity change parameters ΔV_{P} and ΔV_{S} may show greater improvement than other parameters. While impedance changes Δ(V_{P}ρ) and Δ(V_{S}ρ) may show less improvement. The degree of improvement may correspond to how much a parameter is affected by accuracy of the density parameter. In some cases, improvement may occur in Δ(V_{P}/V_{S}), which is an indicator of the presence of oil/gas.

As shown in FIG. 5, certain embodiments of the present disclosure may be implemented with a hardware environment that includes an information processor 500, an information storage medium 510, an input device 520, processor memory 530, and may include peripheral information storage medium 540. The hardware environment may be in the well, at the rig, or at a remote location. Moreover, the several components of the hardware environment may be distributed among those locations. The input device 520 may be any data reader or user input device, such as data card reader, keyboard, USB port, etc. The information storage medium 510 stores information provided by the detectors. Information storage medium 510 may include any non-transitory computer-readable medium for standard computer information storage, such as a USB drive, memory stick, hard disk, removable RAM, EPROMs, EAROMs, flash memories and optical disks or other commonly used memory storage system known to one of ordinary skill in the art including Internet based storage. Information storage medium 510 stores a program that when executed causes information processor 500 to execute the disclosed method. Information storage medium 510 may also store the formation information provided by the user, or the formation information may be stored in a peripheral information storage medium 540, which may be any standard computer information storage device, such as a USB drive, memory stick, hard disk, removable RAM, or other commonly used memory storage system known to one of ordinary skill in the art including Internet based storage. Information processor 500 may be any form of computer or mathematical processing hardware, including Internet based hardware. When the program is loaded from information storage medium 510 into processor memory 530 (e.g. computer RAM), the program, when executed, causes information processor 500 to retrieve detector information from either information storage medium 510 or peripheral information storage medium 540 and process the information to estimate a parameter of interest. Information processor 500 may be located on the surface or downhole.

While the foregoing disclosure is directed to the one mode embodiments of the disclosure, various modifications will be apparent to those skilled in the art. It is intended that all variations be embraced by the foregoing disclosure.

We claim:

1. A method of evaluating an earth formation, the method comprising:
estimating at least one parameter of interest of the earth formation using seismic parameters and density information, wherein a processor uses the density information to reduce uncertainty in the seismic parameters.

2. The method of claim 1, further comprising:
estimating the density information using gravity log information.

3. The method of claim 2, wherein the gravity log information is obtained from a borehole gravity log.

4. The method of claim 2, wherein the gravity log information includes at least one of:
i) vertical gravity component information and ii) horizontal gravity component information.

5. The method of claim 2, wherein estimating the density information includes performing an inversion of the gravity log information.

6. The method of claim 5, further comprising:
inverting the vertical seismic parameters jointly with the inversion of the gravity log information.

7. The method of claim 1, wherein the earth formation comprises at least a first layer and a second layer.

8. The method of claim 7, wherein the at least one parameter of interest includes at least one of: i) a P-wave velocity in the first formation layer ii) a P-wave velocity in the second formation layer, iii) a difference between the P-wave velocity in the first formation layer and the P-wave velocity in the second formation layer, iv) an S-wave velocity in the first formation layer, v) an S-wave velocity in the second formation layer, vi) a difference between the S-wave velocity in the first formation layer and the S-wave velocity in the second formation layer vii) a density of the first formation layer, viii) a density of the second formation layer, ix) a difference between the density of the first formation layer and the density of the second formation layer, x) elastic constants of the first formation, and xi) elastic constants of the second formation.

9. The method of claim 1, wherein the seismic parameters correspond to a first borehole and the density information corresponds to a second borehole.

10. The method of claim 1, wherein the seismic parameters include vertical seismic profiling information.

11. An apparatus for evaluating an earth formation, the apparatus comprising:
a gravity data log; and
a processor configured to estimate at least one parameter of interest of the earth formation using seismic parameters and density information, wherein the processor uses the density information to reduce uncertainty in the seismic parameters.

12. The apparatus of claim 11, the processor further configured to:
estimate the density information using gravity log information.

13. The apparatus of claim 12, wherein the gravity log information is obtained from a borehole gravity log.

14. The apparatus of claim 12, wherein the gravity log information includes at least one of: i) vertical gravity component information and ii) horizontal gravity component information.

15. The apparatus of claim 12, wherein density information is estimated using inverted gravity log information.

16. The apparatus of claim 15, the processor being further configured to:
invert the vertical seismic parameters jointly with the inversion of the gravity log information.

17. The apparatus of claim 11, wherein the earth formation comprises at least a first layer and a second layer.

18. The apparatus of claim 17, wherein the at least one parameter of interest includes at least one of: i) a P-wave velocity in a first formation layer ii) a P-wave velocity in a second formation layer, iii) a difference between the P-wave velocity in the first formation layer and the P-wave velocity in the second formation layer, iv) an S-wave velocity in the first formation layer, v) an S-wave velocity in the second formation layer, vi) a difference between the S-wave velocity in the first formation layer and the S-wave velocity in the second formation layer vii) a density of the first formation layer, viii) a density of the second formation layer, and ix) a difference between the density of the first formation layer and the density of the second formation layer, x) an elastic constant of the first formation, and xi) an elastic constant of the second formation.

19. The apparatus of claim 11, wherein the seismic parameters correspond to a first borehole and the density information corresponds to a second borehole.

20. The apparatus of claim 11, wherein the seismic parameters include vertical seismic profiling information
